(19) United States
(12) Patent Application Publication
(10) Pub. No.: US 2006/0124505 A1
(43) Pub. Date: Jun. 15, 2006

(54) Accessory carrying receptacle

(76) Inventor: Chad W. Hanson, Jackson, TN (US)

Correspondence Address: THE BLACK & DECKER CORPORATION, 701 EAST JOPPA ROAD, TW199, TOWSON, MD, 21286, US

(21) Appl. No.: 11/140,612

(22) Filed: May 27, 2005

Related U.S. Application Data
(60) Provisional application No. 60/575,684, filed on May 28, 2004.

(51) Int. Cl. B65D 85/00; A45C 11/26; H01R 33/90

(52) U.S. Cl. 206/702; 439/638; 206/349

(57) ABSTRACT

A receptacle for carrying and storing accessories. In an exemplary embodiment, the accessory carrying receptacle includes a housing for carrying an elongated accessory. The housing includes a base and a generally cylindrical interior so that the elongated accessory may be stored and transported in a wound configuration. Further, in the embodiment, a grasping mechanism is included within the receptacle for assisting a user in transporting the receptacle. Additionally, a storage tray is operationally coupled to the housing for storing an additional accessory. In the embodiment, a housing lid is operationally coupled to the housing for enclosing the housing. The receptacle is configured to carry and store an elongated accessory as well as provide an area for a person to sit.

### CROSS-REFERENCE TO RELATED APPLICATIONS

The present application claims the benefit under 35 U.S.C. §119(e) of U.S. Provisional Application Ser. No. 60/575,684, filed May 28, 2004 which is herein incorporated by reference in its entirety.

### FIELD OF THE INVENTION

The present invention relates to the field of power tools and more particularly to a portable container for transporting tool accessories.

### BACKGROUND

In order to perform a particular job at a given job-site, a user is often required to transport a large number of tools, material, and the like. For example, to operate a pneumatic nailer at a job-site a user may need to transport the nailer, a pneumatic hose, various fasteners, an air compressor, and possibly additional electrical cords. Transportation of such components and materials is often cumbersome for the user is typically required to carry such items separately. Such requirement may lead to a user not being able to operate the tool once arriving at the job-site for one of the necessary components was either not transported or lost during transportation. Further, another limitation associated with such requirement is the need to find storage space for such components once at the worksite.

An additional problem which confronts a user at a conventional job-site is the lack of a place to sit. Most job-sites do not provide chairs, stools, or like on which a user may sit to either perform a certain job or to rest. For instance, some jobs are best performed while sitting down. As such, a user may be required to kneel down or sit on the ground which is not only uncomfortable, but wearing on ones knees and back. One possible solution to such problem is the separate transportation of a stool, step, or the like to the job-site. Such solution is disadvantageous for it requires a user to transport a stool or like in addition to the aforementioned tools and materials to perform a particular job.

Therefore, it would be desirable to provide an accessory carrying receptacle configured to accommodate the transportation and storage of various tools and accessories and being able to function as a stool.

### SUMMARY OF INVENTION

Accordingly, the present invention is directed to an accessory carrying receptacle. The disclosed accessory carrying receptacle is configured to accommodate the storage and transport of various tools and accessories. The accessory carrying receptacle is designed to facilitate the storage and transport of elongated accessories such as pneumatic hoses, electrical cords, and the like which benefit from being stored in a wound configuration. In addition, the accessory carrying receptacle is configured to be utilized as a stool.

In a first aspect of the present invention, the accessory carrying receptacle includes a housing for carrying and storing a plurality of accessories. The housing including a base and a generally cylindrical interior so that an elongated accessory may be stored and transported in a wound configuration. Further, in the aspect, a grasping mechanism is included which assists in transporting the receptacle. Additionally, a storage tray is operationally coupled to the housing for storing accessories. For instance, a storage trays may be configured to receive additional storage trays. This configuration may allow a single storage lid to secure the accessories stored within the storage trays. In the present aspect, a housing lid is operationally coupled to the housing for enclosing the housing and provides an area for sitting. For example, the housing lid includes a plurality of ribs for rigidity. Thus, the present receptacle is configured to carry and store an elongated accessory as well as provide an area for a person to sit.

In further aspects of the present invention, the receptacle for carrying and storing accessories includes an internal container coupled to the housing base. In such aspect, the internal container is generally cylindrical in shape so that the elongated accessory may be wound about the cylinder during storage and transport and other accessories may be stored and transported inside the internal container. The internal container may be integrally formed with the base of the housing or mounted to the base of the housing via fasteners. Additionally, the internal container may include a lid for securing the accessories within the container during transport and storage.

In additional aspects of the present invention, the housing includes an aperture. In the present aspect, the aperture is positioned so that a first end of the elongated accessory may extend outside the housing and connect to a corresponding device while a second end of the elongated accessory may be uncoiled from an open end of the housing. Moreover, the aperture may be incremental allowing the aperture to operate in different positions.

In even further aspects of the present invention, the grasping mechanism may include generally opposing mounted handles adjacent an end of the housing to aid grasping during transport. For example, the handles are molded with finger shaped contours to provide a comfortable grip when lifting the receptacle. Moreover, one or more straps may be included which attach to the housing, a handle, or the like, allowing the receptacle to be transported without the use of hands.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF DRAWINGS

The numerous advantages of the present invention may be better understood by those skilled in the art by reference to the accompanying figures in which:

FIG. 1 is an exploded view of an accessory carrying receptacle in accordance with the present invention, wherein the accessory carrying receptacle includes an internal container;

FIG. 2 is a cross-sectional view of an accessory carrying receptacle in accordance with the present invention, wherein the positioning of an elongated accessory and power tool within the receptacle are illustrated;

FIG. 3 is an isometric view of an accessory carrying receptacle in accordance with the present invention, wherein the receptacle includes a strap and a handle providing mechanisms by which the receptacle may be transported;

FIG. 4 is an exploded view of a lid for an accessory carrying receptacle in accordance with the present invention, wherein a series of ribs and a cushion are included within the lid; and

FIG. 5 is an illustration of an accessory carrying receptacle in accordance with the present invention, wherein an aperture is included within the base of the housing for allowing an end of a wound accessory to be accessed.

### DETAILED DESCRIPTION OF THE INVENTION

Reference will now be made in detail to the presently preferred embodiments of the invention, examples of which are illustrated in the accompanying drawings.

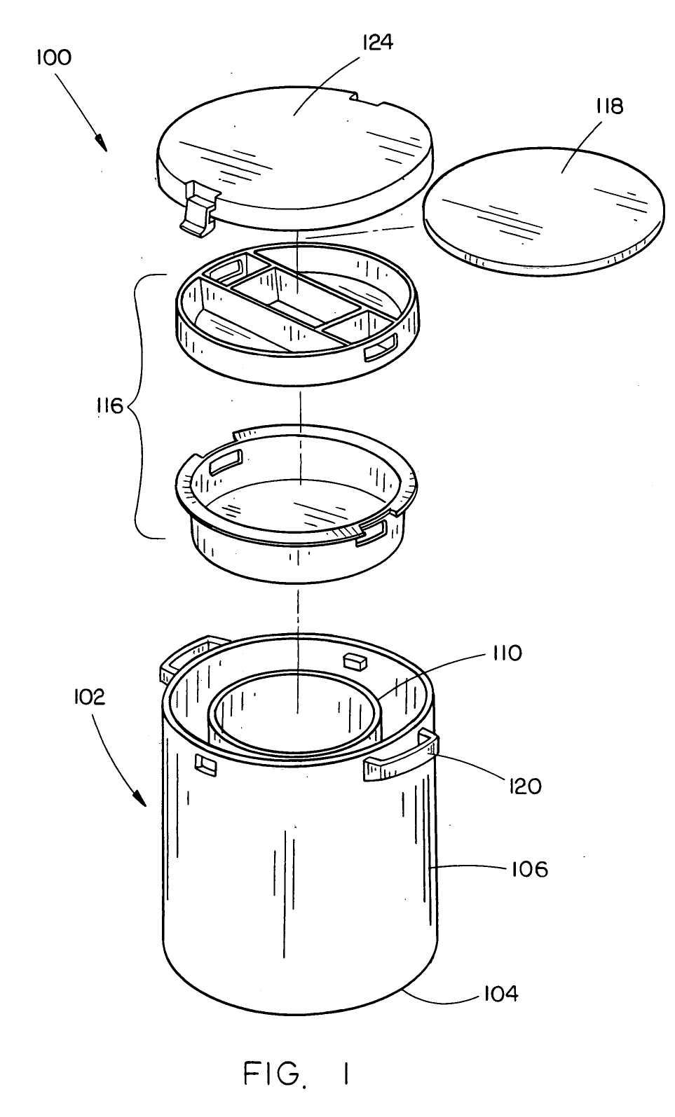

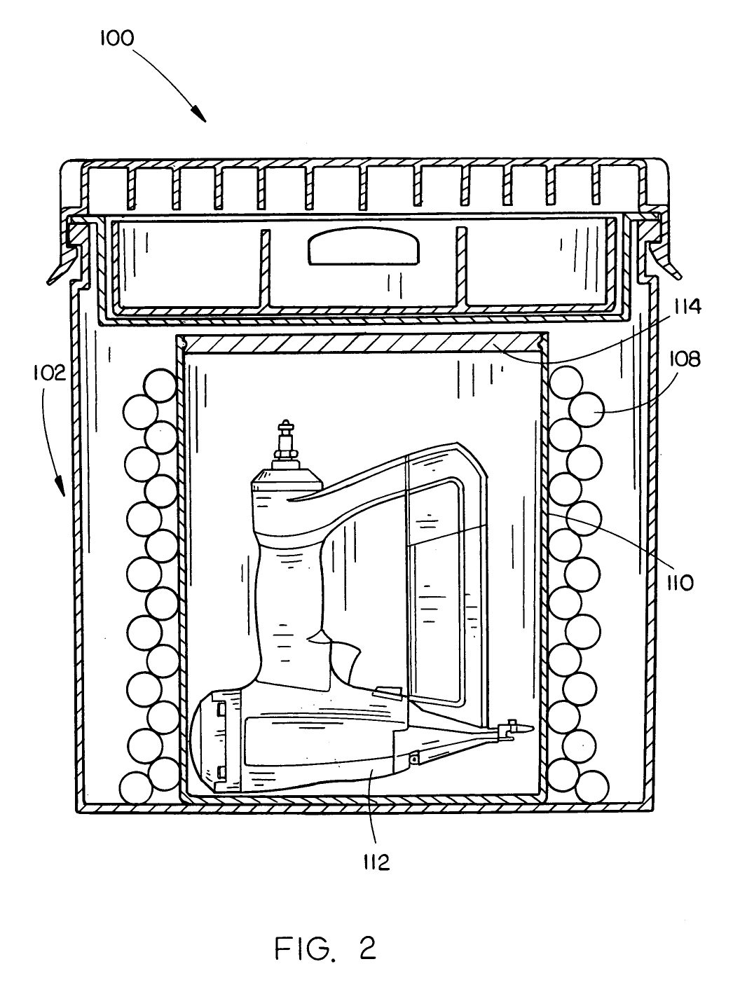

Referring now to FIGS. 1 and 2, an accessory carrying receptacle 100 in accordance with the present invention including a housing 102 for carrying and storing a plurality of accessories, including an elongated accessory, is provided. In an embodiment, the housing 102 includes a base 104 and at least one side wall 106. In the present embodiment, the interior of the housing 102 is generally cylindrical so that an elongated accessory 108 (e.g., a cord for a compressor, pressure washer, generator, or the like) may be stored and transported in a wound configuration. In a preferred embodiment, the exterior of the housing 102 is generally cylindrical to conserve material. However, other configurations for the exterior of the housing including a square are contemplated.

In a further embodiment, in addition to the interior of the housing 102 being generally cylindrical, the housing 102 may include an internal container 110 for assisting in the storage of an elongated accessory in a wound position. As illustrated in FIGS. 1 and 2, the internal container 110 may be generally cylindrical with a hollow center so that the elongated accessory may be wound about the cylinder during storage and transport and other larger accessories (such as a nailer 112, a tool for a compressor, generator, pressure washer, and the like) may be stored and transported inside the internal container 110.

In an embodiment, a cylindrical recess is maintained between the side of the internal container 110 and housing 102 for the storage of elongated accessories. Further, the internal container 110 is coupled to the center of the interior base of the housing 102. For instance the housing 102 may be molded with an internal container 110. Alternatively, the internal container 110 may be coupled to the interior of the housing via a fastener including using a snap, screw configuration, or the like to permit removal of the internal container for accessibility or additional space. In addition, a lid may be used to secure the internal container's contents when the housing is inverted, attached using couplings such as a hinge, spring-loaded clip, screw configuration, or the like to secure the lid to the internal container.

In further exemplary embodiments, as illustrated in FIG. 1, the accessory carrying receptacle 100 includes a storage tray 116 for storing and transporting varying sized accessories and materials. In an embodiment, a storage tray 116 includes a grouping of removable trays that accommodate the storage of various tool accessories inside the accessory carrying receptacle. In a separate embodiment, a single tray may be used to accommodate a large tool accessory. The storage trays may be subdivided for general storage such as nails, adapters, or may be specifically shaped for specific accessories or type of accessories such as a finishing nail gun. An internal shelf or ledge in the housing 102 may allow the trays to be disposed at a desired spatial position inside the housing 102.

In an embodiment, as illustrated in FIG. 1, storage trays may be connected together in order to allow some or all of the storage trays to be removed at a time from the accessory carrying receptacle 100. For example, the storage trays may thread together when stacked, nest partially within each other, or be connected to one another using an off-center shaft which the trays twist around to expose their contents. These configurations allow the bottom surface of each storage tray to operate as a lid for any adjacent lower storage tray when they are connected, thus requiring only a single storage tray lid 118 to secure the contents when inverted. A storage tray lid may be connected as necessary to each storage tray using a hinge, spring-loaded clip, screw configuration, or the like.

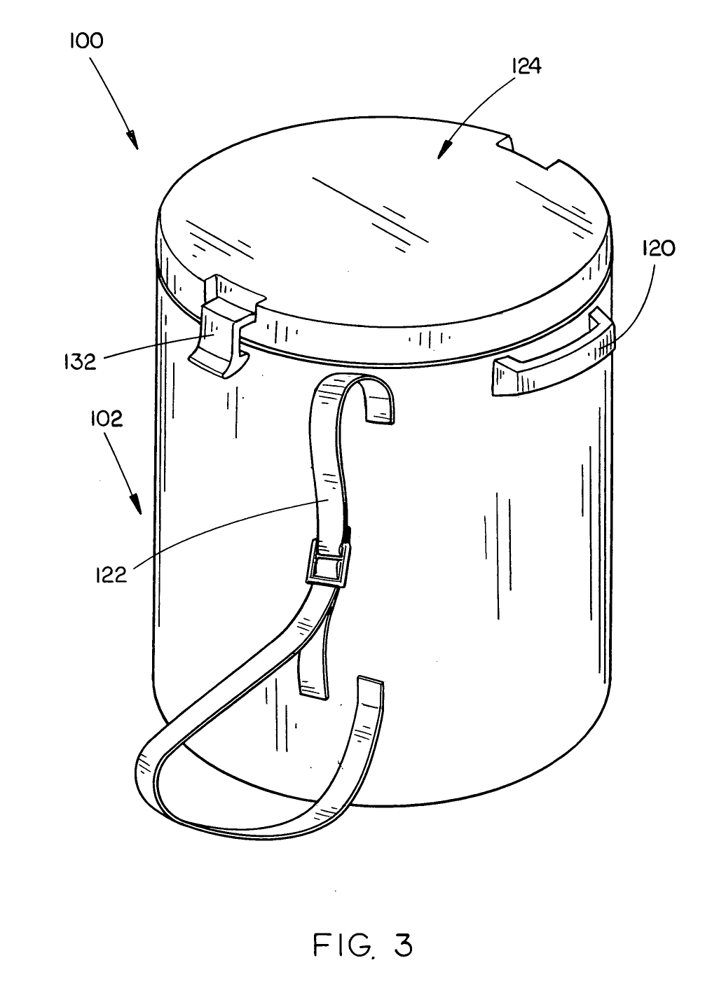

Referring to FIG. 3, an exemplary embodiment of an accessory carrying receptacle 100 including a mechanism for grasping the receptacle during transportation is provided. In an embodiment, the accessory carrying receptacle 100 includes generally opposing mounted handles referred to generally as 120 adjacent an end of the housing 102 to aid grasping during transport. For instance, the handles 120 may be molded or coupled to the housing 102 or a housing lid 124. In the alternative, a bail type handle may be utilized. Additionally, the handles 120 may be ergonomically designed using contours, surface texturing, or elastic materials to provide a comfortable grip when lifting the receptacle 100. For example, the handles 120 are molded with finger shaped contours or composed of a textured elastomeric material.

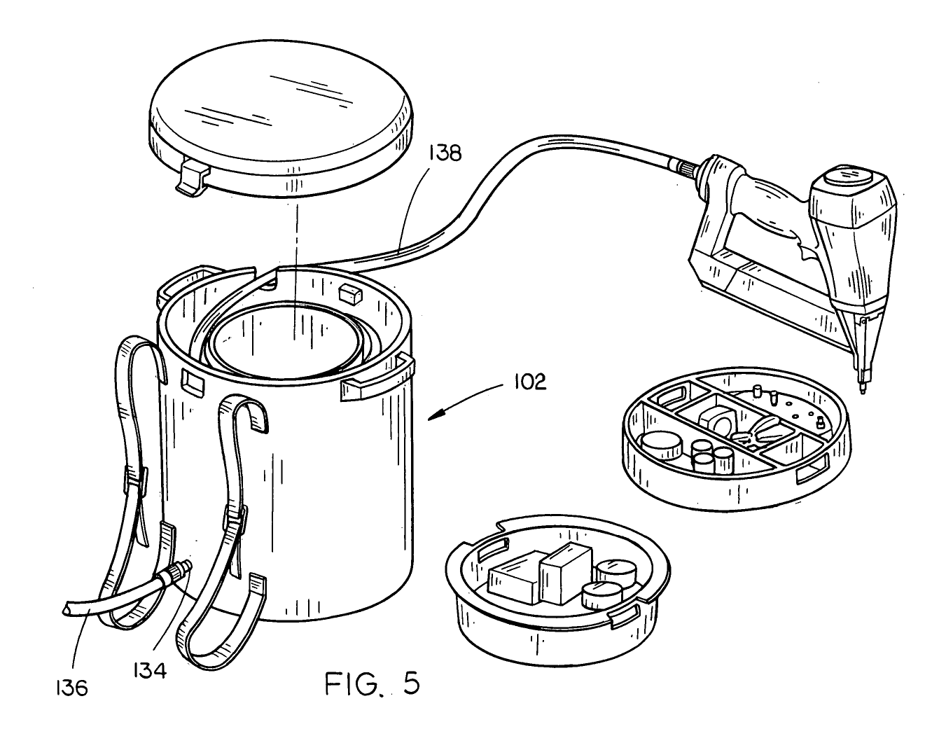

As illustrated in FIG. 3, one or more straps 122 may be included within the accessory carrying receptacle 100 allowing for hands-free transportation of the receptacle 100. For instance, a single strap may allow a user to transport the accessory carrying receptacle by positioning the strap over one's shoulder or across one's chest. In an alternative embodiment, as illustrated in FIG. 5, two straps may be included to form a backpack configuration allowing for extended transport and even distribution of load. It is contemplated that the one or more straps 122 may be attached to the housing 102 of the accessory carrying receptacle 100 via adhesive, fasteners, or like. In addition, the one or more straps 122 may be secured to the handles 120.

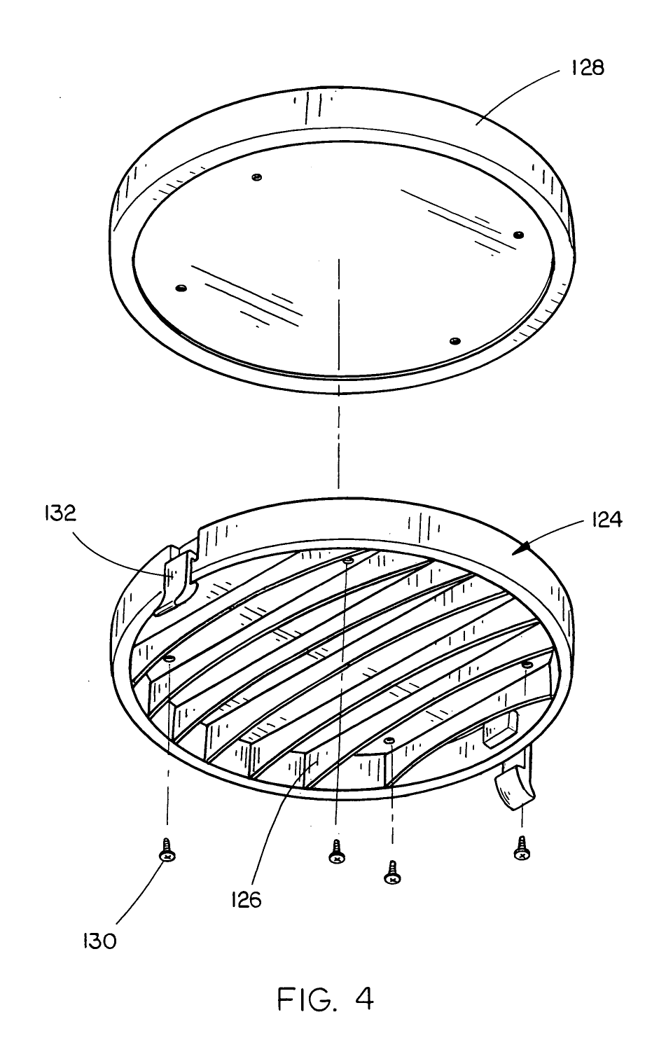

Referring to FIGS. 1 and 4, an exemplary housing lid 124 which encloses the housing 102 and provides an area for sitting is shown. In an embodiment, the housing lid 124 is configured to support a person's weight when the accessory carrying receptacle is used as a stool or a step. As illustrated in FIG. 4, the housing lid 124 may employ a plurality of ribs (generally 126) to create a rigid support such as by distributing a person's weight to the housing 102. In a further embodiment, the exterior-facing surface of the housing lid 124 may be covered by a pad (i.e. cushion material) 128 or the housing lid may be contoured for user comfort. In such embodiment, the pad 128 may be secured to the exterior surface of the housing lid 124 via fasteners, adhesive, and the like. For example, as illustrated in FIG. 4, a plurality of screws 130 may be inserted through apertures extending through the housing lid 124 and into corresponding apertures present in a bottom surface of the pad 128.

In additional embodiments, the housing lid 124 may have a net attached to the interior-facing surface of the lid to accommodate the storage of tool accessories. For example, the lid 124 may contain clips, snaps, elastic loops, or similar holders to allow tool accessories to be affixed. In an alternative embodiment, the housing lid 124 may operate as a container incorporating a hollow core with an entry on a side for the storage of thin tool accessories. In further embodiments, the housing lid 124 may be coupled to the housing 102 using a hinge, spring-loaded clip, a pressure tab, screw configuration, or the like to secure the housing lid 124 to the housing 102. For example, as illustrated in FIG. 3, the housing lid 124 is secured to the housing 102 via a pressure tab 132.

Referring to FIG. 5, an accessory carrying receptacle 100 including an aperture 134 within the housing 102 for allowing a wound accessory to be easily accessed. In an exemplary embodiment, the housing 102 may include the aperture 134 located on the sidewall 106 adjacent to the base 104 of the housing 102 to permit easy extraction of a wound accessory, such as a pneumatic hose or electrical cord, which extend through the housing. In the embodiment, as illustrated in FIG. 5, the aperture 134 permits a tail end 136 of a wound or elongated accessory to extend outside the housing 102 for easy connection to a corresponding device (e.g. pneumatic hose to a compressor) while the other end 138 of the elongated accessory may be uncoiled from the open-end of the housing 102 as needed. In additional embodiments, a recess 140 may be included in the housing generally opposite the end of the sidewall 106 which is attached to the base for providing an area in which a wound accessory may freely flow. For example, as illustrated in FIG. 5, during use, an end of the elongated accessory which is coupled to a tool may be placed within the recess 140 which allows a user to easily extend the wound accessory to the desired length. In the alternative, the elongated accessory may be entirely removed from the housing when utilized.

In a further embodiment, the aperture 134 may be closed with a cover, such as a plug, sliding cover, or the like, to prevent the ingress of dirt and debris inside the receptacle 100. In addition, the cover may open in stages providing an intermediate position creating a tight fit around the tail end of the hose or cord and a fully open position to allow the wound accessory to freely move through the housing without interference from the cover. It is contemplated that the cover may be coupled to the housing in order to prevent the separation of the cover when it is not connected to the aperture by such means as an anchor, spring-loaded clip, groove, or the like.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A receptacle for carrying and storing accessories, comprising:
a housing configured to carry an elongated accessory, the housing including a base and a generally cylindrical interior so that an elongated accessory may be stored and transported in a wound configuration;
means for grasping the receptacle during transportation;
a storage tray operationally coupled to the housing for storing an additional accessory; and
a housing lid operationally coupled to the housing for enclosing the housing, the housing lid being configured for sitting,
wherein the receptacle is configured to carry and store an elongated accessory in a wound configuration as well as provide an area to sit.

2. The receptacle for carrying and storing accessories as claimed in claim 1, further comprising an internal container coupled to the housing base, the internal container being generally cylindrical in shape so that the elongated accessory may be wound about the cylindrical container during storage and transport and the additional accessory may be stored and transported inside the internal container.

3. The receptacle for carrying and storing accessories as claimed in claim 2, wherein the coupling of the internal container to the housing base is selected from the group consisting of integral formation of the internal container with the base and fastening the internal container to the base via fasteners.

4. The receptacle for carrying and storing accessories as claimed in claim 2, wherein the internal container includes a lid for securing the additional accessory within the container during transport and storage.

5. The receptacle for carrying and storing accessories as claimed in claim 1, wherein the housing includes an aperture, the aperture positioned so that a first end of the elongated accessory may extend outside the housing and connect to a corresponding device while a second end of the elongated accessory may be uncoiled from an open end of the housing.

6. The receptacle for carrying and storing accessories as claimed in claim 1, wherein the means for grasping is selected from the group consisting of generally opposing mounted handles adjacent an end of the housing, generally opposing handles with finger shaped contours molded within the housing, and bail type handles.

7. The receptacle for carrying and storing accessories as claimed in claim 1, further comprising one or more straps attached to the housing for allowing the receptacle to be transported without the use of hands.

8. The receptacle for carrying and storing accessories as claimed in claim 1, wherein the housing lid includes a plurality of ribs for rigidity.

9. The receptacle for carrying and storing accessories as claimed in claim 1, wherein the storage tray is configured to accept additional storage trays so that each storage tray may operate as a lid for an adjacent storage tray.

10. The receptacle for carrying and storing accessories as claimed in claim 1, wherein the housing lid includes a fastener to secure the lid to housing during transport.

11. The receptacle for carrying and storing accessories as claimed in claim 10, wherein the fastener is a pressure tab.

12. A receptacle for carrying and storing accessories, comprising:
a housing configured to carry a plurality of accessories, the housing including a base, a generally cylindrical interior, and a carrying mechanism, the plurality of accessories including an elongated accessory;
an internal container disposed within the housing base, the internal container being generally cylindrical in shape providing an area in which the elongated accessory may be wound;
a storage tray operationally coupled to the housing for storing the plurality of accessories, the storage tray being configured so that each storage tray may operate as a lid for an adjacent lower storage tray so that a single storage lid may secure the accessories stored and transported within the plurality of storage trays; and
a housing lid configured to attach to the housing for enclosing the housing, the housing lid being designed for sitting,
wherein the receptacle is configured so that the elongated accessory may be wound about the cylindrical internal container during storage and transport and other accessories included within the plurality of accessories may be stored and transported inside the internal container.

13. The receptacle for carrying and storing accessories as claimed in claim 12, wherein the internal container is integrally formed with the base of the housing.

14. The receptacle for carrying and storing accessories as claimed in claim 12, wherein the internal container is mounted to the base of the housing via fasteners.

15. The receptacle for carrying and storing accessories as claimed in claim 12, wherein the internal container includes a lid for securing the accessories within the container during transport and storage.

16. The receptacle for carrying and storing accessories as claimed in claim 12, wherein the housing includes an aperture, the aperture positioned so that a first end of the elongated accessory may extend outside the housing and connect to a corresponding device while a second end of the elongated accessory may be uncoiled from an open end of the housing.

17. The receptacle for carrying and storing accessories as claimed in claim 12, wherein the carrying mechanism is selected from the group consisting of generally opposing mounted handles adjacent an end of the housing, generally opposing handles with finger shaped contours molded within the housing, bail type handles, and at least one strap attached to the housing.

18. The receptacle for carrying and storing accessories as claimed in claim 12, wherein the housing lid includes a fastener to secure the lid to housing during transport.

19. A receptacle for carrying and storing an accessory, the receptacle including a generally cylindrical interior for providing an area in which an elongated accessory may be wound, comprising:
a housing configured to carry at least one accessory;
means for carrying at least one accessory in a wound configuration;
a housing lid configured to attach to the housing for enclosing the housing, the housing lid being designed for sitting,
wherein the means for carrying at least one accessory is disposed within the housing so that the at least one accessory may be stored in a wound configuration and the housing lid may be used as a seat.

20. The receptacle for carrying and storing an accessory as claimed in claim 19, wherein the means for carrying the at least one accessory in a wound position is a generally cylindrical internal container.
